(19) United States
(12) Patent Application Publication
(10) Pub. No.: US 2010/0002909 A1
(43) Pub. Date: Jan. 7, 2010

(54) Method and device for detecting in real time interactions between a user and an augmented reality scene

(75) Inventors: Valentin LEFEVRE, Puteaux (FR); Nicolas Livet, Paris (FR); Thomas Pasquier, Libourne (FR)

Correspondence Address: BROWDY AND NEIMARK, P.L.L.C.;624 NINTH STREET, NW, SUITE 300, WASHINGTON, DC, 20001-5303, US

(73) Assignee: TOTAL IMMERSION, Suresnes (FR)

(21) Appl. No.: 12/495,402

(22) Filed: Jun. 30, 2009

(30) Foreign Application Priority Data
Jun. 30, 2008 (FR) 0854382

(51) Int. Cl. G06K 9/46

(52) U.S. Cl. 382/103; 382/190

(57) ABSTRACT

The invention consists in a system for detection in real time of interactions between a user and an augmented reality scene, the interactions resulting from the modification of the appearance of an object present in the image. After having created (110) and processed (115) a reference model in an initialization phase (100), the pose of the object in the image is determined (135) and a comparison model is extracted from the image (160). The reference and comparison models are compared (170), as a function of said determined pose of the object, and, in response to the comparison step, the interactions are detected.

The present invention concerns the combination of real and virtual images in real time, also known as augmented reality, and more particularly a method and a device enabling interaction between a real scene and a virtual scene, i.e. enabling interaction of one or more users with objects of a real scene, notably in the context of augmented reality applications, using a system for automatically tracking those objects in real time with no marker.

The object of augmented reality is to insert one or more virtual objects into the images of a video stream. Depending on the type of application, the position and the orientation of these virtual objects can be determined by data external to the scene represented by the images, for example coordinates coming directly from a game scenario, or by data linked to certain elements of that scene, for example coordinates of a particular point of the scene such as the hand of a player. When the position and the orientation are determined by data linked to certain elements of the scene, it can be necessary to track those elements as a function of the movements of the camera or of the movements of these elements themselves in the scene. The operations of tracking elements and of embedding virtual objects in the real images can be executed by separate computers or by the same computer.

There are a number of methods for tracking elements in a stream of images. Element tracking algorithms, also known as target pursuit algorithms, generally use a marker, which can be visual, or use other means such as RF or infrared means. Alternatively, some algorithms use shape recognition to track a particular element in an image stream.

The objective of these visual tracking, or sensor tracking, algorithms is to locate, in a real scene, the pose, i.e. the position and the orientation, of an object for which geometry information is available, or to retrieve extrinsic position and orientation parameters from a camera filming that object, thanks to image analysis.

The applicant has developed an algorithm for visual tracking of objects that does not use a marker and the novelty of which resides in the matching of particular points between the current image from a video stream and a set of key images obtained automatically on initialization of the system.

However, a widely accepted limitation of augmented reality systems is the lack of interaction of a user with the observed real scene. Although there are a number of solutions adapted to provide such interactivity, they are based on complex systems.

A first approach uses sensors associated with the joints of a user or an actor, for example. Although his approach is most often dedicated to movement capture applications, in particular for cinematographic special effects, it is also possible to track the position and the orientation in the space of an actor and, in particular, their hands and their feet, to enable them to interact with a virtual scene. However, the use of this technique proves costly, as it is mandatory to insert into the scene bulky sensors that can furthermore suffer interference in specific environments.

Multiple camera approaches have also been used, for example in the European “OCETRE” and “HOLONICS” projects, in order to obtain a reconstruction in real time of the environment and the spatial movements of users. One example of such approaches is described in particular in the document “Holographic and action capture techniques”, T. Rodriquez, A. Cabo de Leon, B. Uzzan, N. Livet, E. Boyer, F. Geffray, T. Balogh, Z. Megyesi et A. Barsi, August 2007, SIGGRAPH '07, ACM SIGGRAPH 2007 emerging technologies. It should be noted that these applications can reproduce the geometry of the real scene but at present cannot locate precise movements. Moreover, to satisfy real time constraints, it is necessary to put into place complex and costly hardware architecture.

There are also touch-sensitive screens used to display augmented reality scenes that determine the interactions of a user with an application. However, these screens are costly and not well suited to augmented reality applications.

In the field of video games, an image is first captured from a webcam type camera connected to a computer or a console. This image is usually stored in the memory of the system to which the camera is connected. An object tracking algorithm, also known as a blobs tracking algorithm, is then used to calculate in real time the contours of certain elements of the user moving in the image thanks, in particular, to the use of optical stream algorithms. The position of these forms in the image is used to modify or deform certain parts of the displayed image. This solution thus localizes the interference in an area of the image according to two degrees of freedom.

However, the limitations of this approach are primarily the lack of precision because it is not possible to maintain correct execution of the method on movement of the camera and the lack of semantics because it is not possible to distinguish movements between the foreground and the background. Moreover, this solution uses optical stream image analysis which, in particular, is not robust in the face of lighting changes or noise.

There is also an approach using an object tracking system to detect a shape, for example the shape of a hand, above a predetermined object consisting of a planar sheet comprising simple geometrical shapes. This approach is limited, however, in the sense that it is not very robust in the face of noise and lighting changes and works only with a specific object containing geometrical patterns such as large black rectangles. Moreover, a stabilizer must be used to detect occlusions, which means that large movements of the camera cannot be carried out during detection.

Thus, the above solutions do not offer the performance and simplicity of use required for numerous applications. There is consequently a need to improve the robustness in the face of lighting, noise in the video stream and movements, applicable to real environments comprising no particular marker or sensor, at the same time as proposing a system having an acceptable price.

The invention solves at least one of the problems stated hereinabove.

Thus, the invention consists in a method of detection in real time of at least one interaction between a user and an augmented reality scene in at least one image from a sequence of images, said at least one interaction resulting from the modification of the appearance of the representation of at least one object present in said at least one image, this method being characterized in that it comprises the following steps:
in an initialization phase,
   creation of at least one reference model associated with said at least one object;
   processing of said at least one reference model;
in a use phase:
   determination of the pose of said at least one object in said at least one image;
   extraction of at least one comparison model from said at least one image according to said at least one object; and
   comparison of said at least one processed reference model and said at least one comparison model as a function of said determined pose and detection of said at least one interaction in response to said comparison step.

Thus, the method of the invention enables a user to interact in real time with an augmented reality scene. The objects used to detect the interactions can move, as can the source from which the sequence of images comes. The method of the invention is robust in the face of variations of the parameters of the processed images and can be executed by standard hardware.

Said step of determination of the pose of said at least one object in said at least one image preferably uses an object tracking algorithm.

Said steps of the use phase are advantageously repeated at least once on at least one second image from said sequence of images. The method of the invention therefore detects interactions in each image of a sequence of images, continuously.

The method preferably further comprises a step of recursive processing of the result of said comparison step to improve the quality and the robustness of interaction detection.

In one particular embodiment, said step of processing said at least one reference model comprises a step of definition of at least one active area in said at least one reference model, said method further comprising a step of determination of said at least one active area in said comparison model during said use phase, said comparison step being based on said active areas. Thus the method of the invention analyzes the variations of particular areas of the images and associates different actions according to those areas.

Still in one particular embodiment, the method further comprises the determination of at least one reference point in said at least one active area of said at least one reference model, said comparison step comprising a step of location of said at least one reference point in said active area of said comparison model.

Still in one particular embodiment, said comparison step comprises a step of evaluation of the correlation of at least one part of said at least one processed reference model and at least one part of said at least one comparison model. Alternatively, said comparison step comprises a step of evaluation of the difference of at least one part of said at least one processed reference model and at least one part of said at least one comparison model. The method of the invention thus compares the variation of the representation of an object between a reference view and a current view in order to detect disturbances that could be associated with an interaction command.

Still according to one particular embodiment, said step of creation of said reference model comprises a step of geometric transformation of homographic type of a representation of said at least one object. It is thus possible to obtain a reference model directly from a representation of the object and its pose.

Still according to one particular embodiment, said at least one comparison model is determined according to said pose of said at least one object, said step of extraction of said comparison model comprising a step of geometric transformation of homographic type of at least one part of said at least one image. It is thus possible to obtain a comparison model from a representation of the object and its pose, that comparison model being comparable to a reference model representing the object according to a predetermined pose.

Still according to one particular embodiment, said step of determination of said reference model comprises a step of determination of at least one Gaussian model representing the distribution of at least one parameter of at least one element of said reference model. Thus the method of the invention compares the variation of the representation of an object between a reference view and a current view in order to detect disturbances that could be associated with an interaction command. The method of the invention is thus robust in the face of disturbances, notably variations of colorimetry and lighting.

To measure the similarity between the representations of the reference and comparison models said comparison step advantageously comprises a step of evaluation of a measurement of a distance between at least one point of said comparison model corresponding to said at least one point of said reference model and said Gaussian model associated with said at least one point of said reference model.

According to one particular embodiment, the method further comprising a step of determination, during said utilization phase, of a representation of said reference model according to said pose of said at least one object and according to said reference model that comprises a three-dimensional geometrical model and an associated texture. The method of the invention thus compares part of the current image to the representation of the reference model, according to the pose of the object.

The method advantageously further comprises a step of activation of at least one action in response to said detection of said at least one interaction.

According to one particular embodiment, said modification of the appearance of said at least one object is the result of the presence of an object, referred to as the second object, separate from said at least one object, between said at least one object and the source of said at least one image.

Still according to one particular embodiment, said modification of the appearance of said at least one object results from a modification of said at least one object.

The invention also consists in a computer program comprising instructions adapted to execute each of the steps of the method described hereinabove and a device comprising means adapted to execute each of the steps of the method described hereinabove.

Other advantages, aims and features of the present invention emerge from the following detailed description, given by way of nonlimiting example, with reference to the appended drawings, in which:

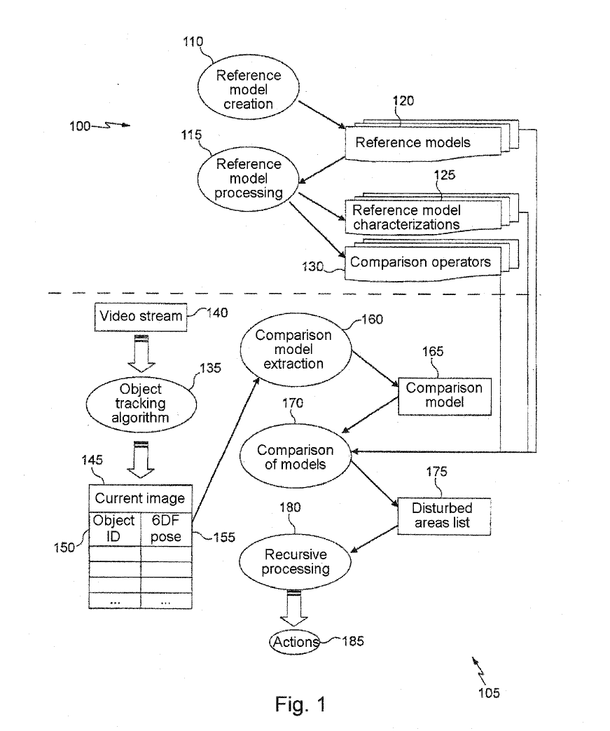

FIG. 1 represents diagrammatically the method of the invention;

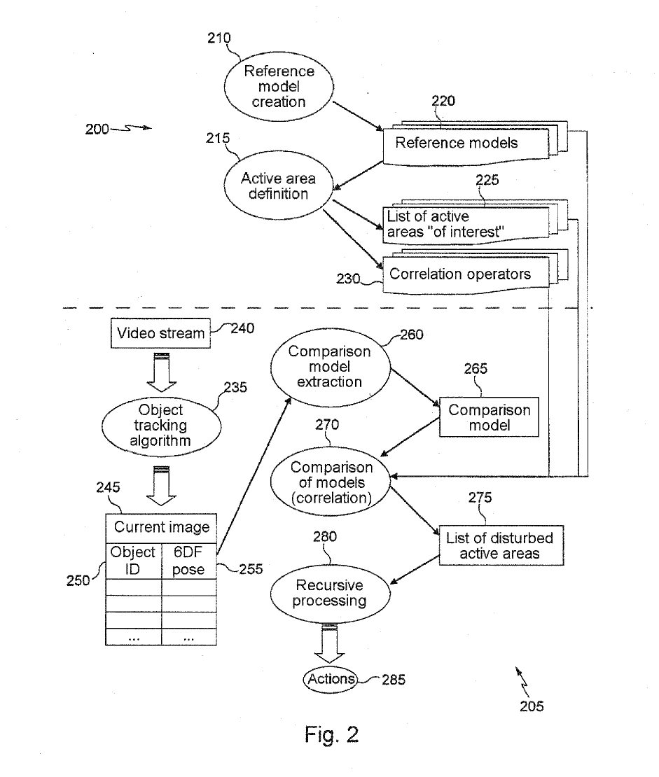

FIG. 2 illustrates diagrammatically a first embodiment of the method of the invention using active areas of the object to be tracked;

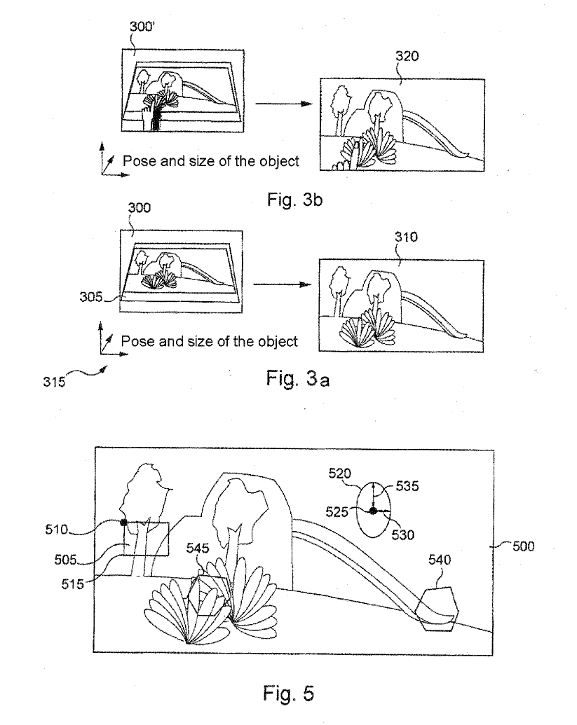

FIG. 3 illustrates an example of determination of a reference or comparison model from an image comprising the object associated with that reference or comparison model;

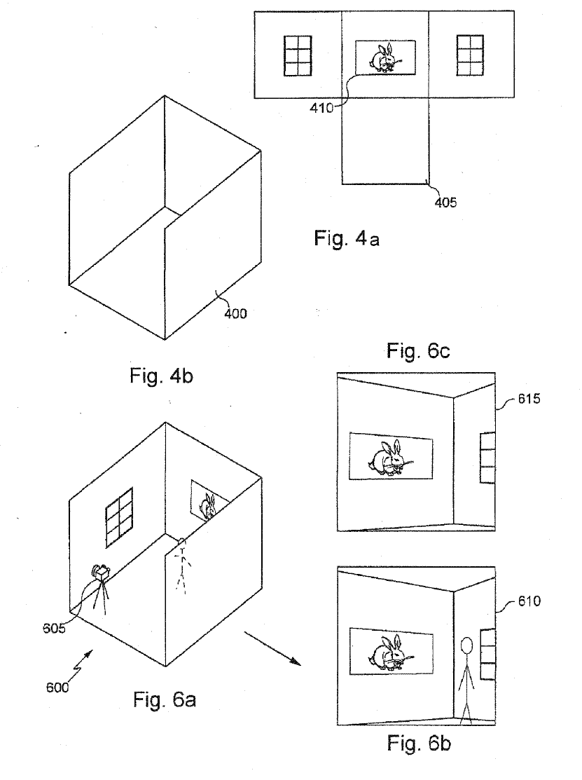

FIG. 4 illustrates an example of a reference model comprising a three-dimensional object and an associated texture;

FIG. 5 gives an example of a reference model of a geometrical object, the reference model comprising a set of active areas;

FIG. 6, comprising FIGS. 6a, 6b and 6c, illustrates an example of determination of a representation of a reference model;

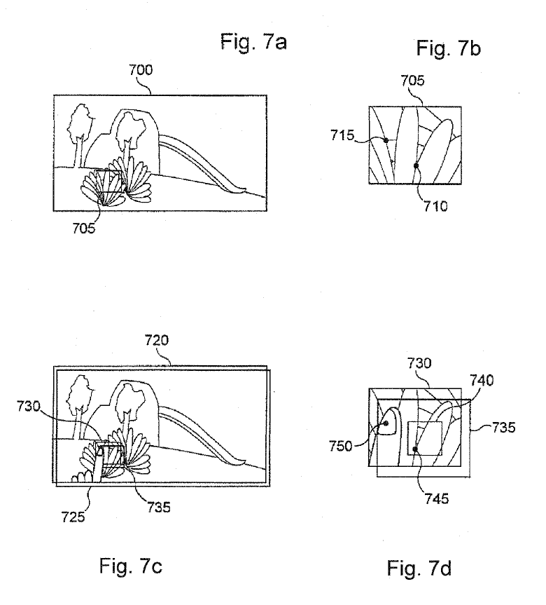

FIG. 7, comprising FIGS. 7a and 7b, illustrates an example of comparison of an active area of a representation of a reference model to that of a comparison model to determine if the active area is disturbed;

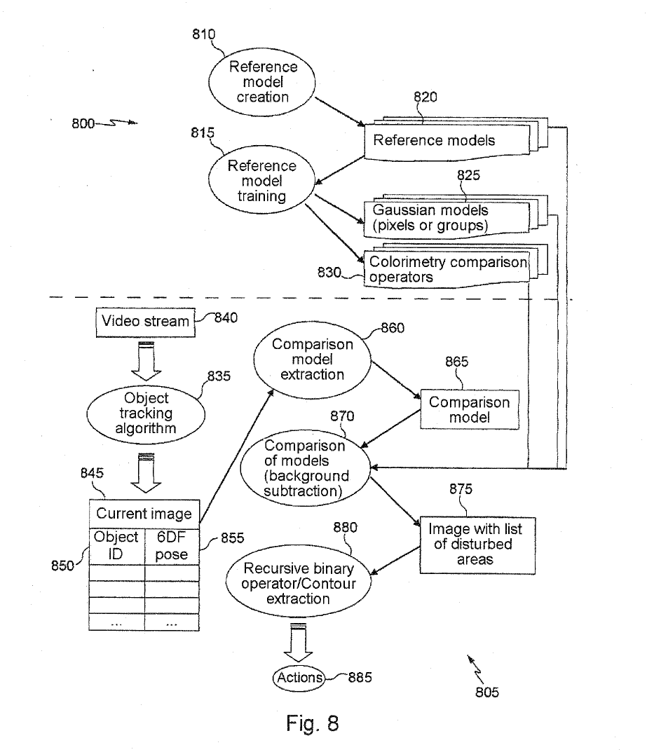

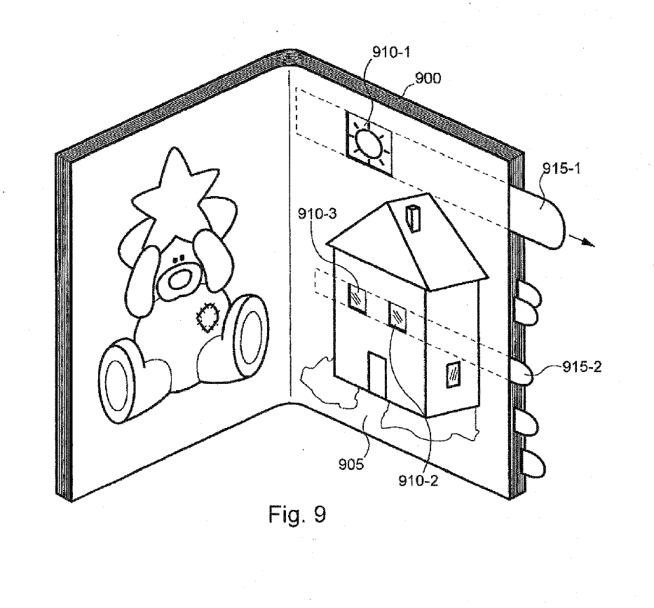

FIG. 8 illustrates diagrammatically a second embodiment of the method of the invention that does not use active areas of the object to be tracked;

FIG. 9 illustrates an example of use of the invention where interaction is detected by the modification of an object; and

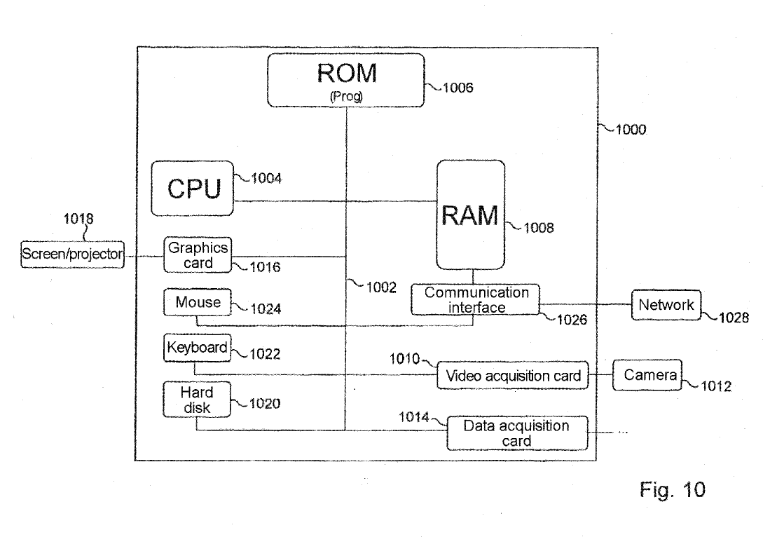

FIG. 10 shows an example of a device for implementing the invention at least in part.

The invention combines algorithms for tracking geometric objects and analyzing images to enable real time detection of interactions between a user and an augmented reality scene. The system is robust in the face of camera movements, movements of objects in the scene and lighting changes.

In simple terms, the system of the invention aims to track one or more objects in a sequence of images to determine, for each image, the pose of the objects. The real pose of the objects is then used to obtain a representation of those objects according to a predetermined pose, by projection of a part of the image. This representation is produced from the image and a predetermined model. The comparison of these representations and the models determines the masked parts of the objects, which masked parts can be used to detect interactions between a user and an augmented reality scene.

FIG. 1 illustrates diagrammatically the method of the invention. As shown, the latter comprises two parts.

A first part 100 corresponds to the initialization phase. In this phase, processing is effected off line, i.e. before the use of real time detection, in a sequence of images, of interactions between a user and an augmented reality scene.

A second part 105 corresponds to the processing effected on line for real time detection, in a sequence of images, of interactions between a user and an augmented reality scene.

The initialization phase does not necessitate the use of an object tracking algorithm. This phase essentially comprises two steps 110 and 115 for creating and processing, respectively, reference models 120.

Here the reference models contain a geometry of the objects from which interactions must be detected and the texture of those objects. In the general case, it is a question of a three-dimensional (3D) generic meshing that is associated with an unfolded image referred to as unrolled (UV map). For plane objects, a simple image is sufficient. At least one reference model must be determined for each object from which interactions must be detected.

The step of creation of reference models 120 (step 110) consists for example in constructing those models from a standard 2D/3D creation software product. The texture of these reference models is preferably constructed from an image extracted from the sequence of images in order to match best the signal coming from the video sensor.

A number of types of processing can be applied to the reference models (step 115) to render the detection of interactions more robust.

A first type of processing consists, for example, in defining, on the reference models, active areas representing a visual interest. These areas can be determined directly on the 3D generic model or on a two-dimensional (2D) projection of that model, in particular by means of an MMI (Man-Machine Interface). An active area can in particular contain a 2D or 3D geometrical shape, an identification and a detection threshold. One such example is described with reference to step 215 in FIG. 2.

Another type of processing consists for example in simulating disturbances on the model in order to take better account of variations of lighting, shadows and noises that can intervene during the phase of real time detection of interactions. One such example is described with reference to the step 815 in FIG. 8.

Such processing obtains the characteristics 125 of the reference models.

The comparison operator 130 used thereafter to detect the interactions is preferably determined during this processing step.

The phase 105 of real time detection of the interactions here necessitates the use of an object tracking algorithm (step 135). This kind of algorithm tracks objects in a sequence of images, i.e. in a video stream 140, for example, on the basis of texture and geometry information.

This type of algorithm determines for each image, in particular for the current image 145, a list of identifiers 150 of the objects present in the image and the poses 155 of those objects according to six degrees of freedom (6DF) corresponding to their position and orientation. A standard object tracking algorithm is used here.

A second step of the detection phase has the object of extracting the comparison model, in the current image 145, for each geometrical object tracked in the sequence of images (step 160). This step consists in particular in extracting the object from the image according to the location of the object obtained by the tracking algorithm and in applying to the object a linear transformation in order to represent it in the frame of reference associated with the reference model.

When the reference model comprises a 3D generic model, the second step further comprises the determination of a projection of the reference model on the basis of the position and the orientation of the current 3D model, determined by the object tracking algorithm and its unfolded texture.

Here the comparison model is referenced 165.

A next step superposes and compares the reference and comparison models using a comparison operator (step 170), over a subset of the corresponding active areas in the two models or over all of the two models if no active area has been defined.

A comparison operator determines the active areas that have been disturbed, i.e. determines which active areas do not match between the reference and comparison models.

Another comparison operator subtracts superpositions of models, for example, the absolute value providing a criterion of similarity for determining the disturbed areas.

The operators can also be applied to all of the models if no active area has been defined. In this case, the active area in fact covers all the models.

These disturbed areas form a list 175 of disturbed areas.

Finally, a recursive programming step (step 180) increases the robustness of the system in order to trigger the actions corresponding to the interactions detected (step 185). These processing actions depend on the targeted application type.

For example, such processing consists in the recursive observation of the disturbances in order to extract a more robust model, to improve the search over the disturbed active areas and/or to refine the extraction of a contour above the object as a function of the disturbed pixels and/or the recognition of a gesture of the user.

FIG. 2 illustrates diagrammatically a first embodiment of the method of the invention using active areas of the object to be tracked. Here an active area is a particular area of an image the modification whereof can generate a particular action enabling interaction of the user with an augmented reality scene.

As indicated hereinabove, the method has a first part 200 corresponding to the initialization phase and a second part 205 corresponding to the processing effected on line for real time detection, in a sequence of images, of interactions between a user and an augmented reality scene.

The initialization phase essentially comprises the steps 210 and 215. Like the step 110, the object of the step 210 is the creation of reference models 220.

In the case of a planar geometrical object, a bidimensional representation, for example an image, of the object to be tracked enables direct construction of the reference model.

If such a representation is not available, it is possible to use an image extracted from the video stream that contains that object and its associated pose, according to its six degrees of freedom, to project the representation of that object and thus to extract the reference model from it. It should be noted here that a reference model can also be obtained in this way for a three-dimensional geometrical object.

The conversion of the coordinates of a point P of the image coming from the sequence of images, the coordinates of which are (x, y, z) in a frame of reference of the object associated with the reference model, in the frame of reference associated with the reference model can be defined as follows:

P′=K.(R.P+T)

where

P′ is the reference of the point P in the frame of reference associated with the reference model, the coordinates of P′ being homogeneous 2D coordinates;

R and T define the pose of the object in the frame of reference of the camera according to its rotation and its translation relative to a reference position; and

K is the projection matrix containing the intrinsic parameters from which the images are obtained.

The matrix K can be written in the following form,

$$K = ( \begin{matrix}fx & 0 & cx \\ 0 & fy & cy \\ 0 & 0 & 1\end{matrix} )$$

where the pair (fx, fy) represents the focals of the camera expressed in pixels and the coordinates (cx, cy) represent the optical center of the camera also expressed in pixels.

In an equivalent manner, the conversion can be expressed by the following geometrical relation:

P′=K.(R.P+R.R^{T}T)=K.R.(P+R^{T}T)

If the reference model represents a plane surface, the points of the reference model can be defined in a two-dimensional frame of reference, i.e. by considering the z coordinate to be zero. Accordingly, replacing R^{T}T according to the relation

$${R}^{T} T = {T}^{′} = ( \begin{matrix}tx \\ ty \\ tz\end{matrix} ) ,$$

the reference of the point P in the frame of reference associated with the reference model is expressed in the following form:

$${P}^{′} ∝ = K . R . ( P + {T}^{′} ) \\ = K . R . ( {[ x y 0 ]}^{′} + {[ tx ty tz ]}^{′} ) \\ = K . R . ( \begin{matrix}1 & 0 & tx \\ 0 & 1 & ty \\ 0 & 0 & tz\end{matrix} ) \cdot ( \begin{matrix}X \\ Y \\ 1\end{matrix} )$$

Thus a geometrical relation of homographic type is obtained. Starting from a point

$$( \begin{matrix}Y \\ X\end{matrix} )$$

expressed in the frame of reference of the object, its correspondent

$${P}^{′} = ( \begin{matrix}u \\ v \\ w\end{matrix} )$$

can be determined in the frame of reference associated with the reference model.

It should be noted that this equality (∝=) is expressed in the homogeneous space that is to say that the equality is expressed with the exception of the scaling factor. The point P′ is therefore expressed by the vector

$${P}^{′} = ( \begin{matrix}u / w \\ v / w \\ 1\end{matrix} ) .$$

Consequently, from the pose of the object in the image concerned, it is possible to retrieve the homography K.R.A. to be applied to the image containing the object.

FIG. 3 illustrates an example of determination of a reference or comparison model from an image 300 comprising the object 305 associated with that reference or comparison model.

As represented, the image 300, coming from a sequence of images, is used to determine the representation 310 of a reference model associated with an object, here the cover of a catalog. The pose and the size of this object, referenced 315, are known and used to project the points of the image 300 corresponding to the object tracked in the representation 310. The size and the pose of the object in the image 300 can be defined by the user or determined automatically using a standard object tracking algorithm.

In the same way, it is possible to obtain the comparison model 320 from the image 300′, the size and the pose of the object in the image 300′ being determined automatically here by means of a standard object tracking algorithm.

In the case of a three-dimensional generic object, one solution, for creating a reference model, is to establish a correspondence between that object and its unfolded texture corresponding to the real object.

FIG. 4 illustrates an example of a reference model comprising a three-dimensional object 400 and an associated texture 405 comprising, in this example, a pattern 410. The form of the texture 405 is determined by the unfolded object 400.

The object 400 represents, for example, a portion of a room formed of a floor and three walls, inside which a user can move.

Returning to FIG. 2, the object of this step 215 is to define the active areas 225 of the tracked object.

An active area is a particular geometrical shape defined in the reference model. The parameters of an active area, for example its shape, position, orientation, size in pixels and identification name, are defined by the user during the initialization phase, i.e. before launching the application. Only these areas are sensitive to detection of disturbances and trigger one or more actions authorizing interaction of the user with an augmented reality scene. There can be areas of overlap between a number of active areas. Moreover, the active areas can represent discontinuous surfaces, i.e. an active area itself comprises a number of interlinked active areas.

The active areas can be defined, for example, by using a user interface and selecting points in the reference model.

FIG. 5 gives an example of a reference model of a geometric object (not shown) comprising a set of active areas.

Here the reference model comprises four areas characterized by a geometrical shape defining a surface. Thus the reference model 500 comprises the active area 505 defined by the point 510 and the rectangular surface 515 defined by the length of its sides. The geometric model 500 also contains the active area 520 defined by the point 525 and the radii 530 and 535 that represent the elliptical surface as well as the active areas 540 and 545 represented by polygons.

The active areas are preferably defined in a reference model frame of reference. The active areas can be defined, in the case of a three-dimensional model, directly on the model itself, for example by selecting a set of facets with a user interface tool.

During this step of defining active areas, the comparison operator 230 that will be used subsequently to detect the interactions is preferably determined.

The phase 205 of real time detection of the interactions necessitates the use of an object tracking algorithm (step 235). Such an algorithm is used to track objects in a sequence of images, i.e. in a video stream 240, for example, on the basis of texture and geometry information.

As indicated above, this type of algorithm determines for each image, in particular for the current image 245, an identifier 250 of each object present in the image and the pose 255 of the object according to six degrees of freedom (6DF) corresponding to the position and to the orientation of the object.

The step 260 of extraction of the comparison model from the current image 245, for each geometrical object to track in the sequence of images, uses the pose information determined by the tracking algorithm, applying to the representation of the tracked object a geometrical transformation for representing it in the frame of reference associated with the reference model.

If the reference model is a plane surface, the extraction of the comparison model is similar to the determination of a reference model as described above and as shown in FIG. 3.

When the reference model comprises a generic 3D model, the comparison model is obtained directly from the current image, by simple extraction of the representation of the tracked object. However, this second step further comprises the determination of a projection of the reference model on the basis of the position and the orientation of the tracked object, determined by the tracking algorithm, and its planar unfolded texture. This projection determines a representation of the reference model that can be compared to the comparison model.

FIG. 6, comprising FIGS. 6a, 6b and 6c, illustrates an example of determination of a representation of a reference model.

FIG. 6a represents a perspective view of a real scene 600 in which a user is located. At least a part of the real, static scene corresponds here to a reference model, i.e. to the tracked object. The camera 605, which can be mobile, takes a sequence of images of the real scene 600, in particular the image 610 represented in FIG. 6b. The image 610 is here considered as the representation of the comparison model.

Starting from the image 610, the tracking algorithm is able to determine the pose of an object. The object tracked being immobile here (environment of the real scene) in the frame of reference of the real scene, the tracking algorithm in reality determines the pose of the camera 605. Alternatively, the tracked object can be in movement.

On the basis of this pose and the reference model comprising a three-dimensional model and an associated texture, for example the three-dimensional model 400 and the associated texture 405, it is possible to project the reference model according to the pose of the camera to obtain the representation 615 of the reference model as shown in FIG. 6c.

In one particular embodiment, the representation of the reference model is obtained by simply reading a working memory of a 3D rendition graphics card. In this case, the graphics card is used in its standard mode. However, the image calculated is not intended to be displayed but is used as a representation of the reference model to determine the disturbed area.

Returning to FIG. 2, here the comparison model is referenced 265.

As indicated above, a subsequent step compares the reference and comparison models, here using a correlation operator (step 270) over all or a portion of the corresponding active areas of the models. The object of this operation is to detect occlusion areas in order to detect the indications of the user to effect one or more particular actions.

Occlusion detection in an active area is based on a temporal comparison of characteristic points in each active area. These characteristic points are, for example, Harris points of interest belonging to the active areas of the reference image.

Thus each active area is characterized by a set of characteristic reference points as a function of the real quality of the image from the camera.

Similarly, it is possible to extract points of interest on the object tracked in real time in the video stream. It should be noted that these points can be determined by the object tracking algorithm. However, these points, notably the points determined by means of a Harris detector, are not robust in the face of some changes of scale, some affine transformations or changes of lighting. Thus the characteristic points are advantageously detected on the reference model, during the off-line step, and on the comparison model, for each new image from the video stream, after the geometric transformation step.

The correspondence between the characteristic reference points, i.e. the characteristic points of the active areas of the reference model, and the current characteristic points, i.e. the characteristic points of the active areas of the comparison model, is then determined. The following two criteria are used to determine the correspondence, for example:
the zero normalized cross correlation (ZNCC) operator for comparing the intensity of a pixel group over a predefined window and to extract therefrom a measure of similarity; and
a distance in the plane operator. The geometrical transformation between the pose of the object in space and the reference model being known, it is possible to measure the distance between a reference characteristic point and a current characteristic point. This distance must be close to zero. It should be noted that this distance being close to zero, a pixel by pixel difference operator can advantageously be used.

Other comparison operators can intervene in the search for matches between the reference model and the comparison model. For example, local jet type descriptors characterize the points of interest in directional manner thanks to using directional derivatives of the video signal, or using SIFT (Scale-Invariant Feature Transform) descriptors or SURF (Speeded Up Robust Features) descriptors. These operators, often more costly in terms of computation time, are generally more robust in the face of geometric variations that occur in the extraction of the models.

Occlusion detection advantageously comprises the following two steps: a step of location of the points corresponding to the reference points of interest in the current image, and an optional step of validation of the correspondence after location.

If the point is not located or if the location of the point is not valid, then there exists an occlusion on that point. Reciprocally, if the point is located and the location of the point is valid, then there exists no occlusion of that point.

It should be noted that if the current pose of the tracked object were perfect and the tracked object were totally rigid, the step of location of the points corresponding to the reference points of interest in the current image, denoted Pr, would not be necessary. In fact, in this case, the current image reprojected into the frame of reference of the reference model would be perfectly superposed on the latter. The ZNCC operator can then be used only over a window about the point Pr to detect occlusions.

However, object tracking algorithms are often limited in terms of their pose calculation accuracy. These errors can be linked, for example, to deformations of the object to be tracked. The planar coordinates (u, v) of a point p belonging to the set Pr are thus estimated by the coordinates (u+uₑᵣᵣ, v+vₑᵣᵣ) in the comparison image.

Consequently, seeking each point p in a window around the ideal position (u, v) is recommended. During this location step, it is not necessary to use a too large window to locate reliably the position of the correspondence of the point p in the current image (if that point is not occluded). The search window must nevertheless remain large enough to take into consideration the errors of the object tracking algorithm at the same time as avoiding processing that is too costly in terms of performance.

The location step can indicate a positive correlation, i.e. indicate the position of a point corresponding to a reference point of interest in the current image although that point is not present in the current image.

To avoid such errors, a second correlation calculation that is more restrictive in terms of the correlation threshold is preferably applied to a larger window around the point in each image in order to validate the location. The larger the correlation window, the more reliable the correlation result.

These location and validation steps can be implemented with other correlation operators, the above description not being limiting.

At the end of processing, a number of reference points of interest that have been detected as occluded is obtained for each active area.

To determine if an active area must be considered disturbed, it is possible to use, over that area, the ratio of the number of reference points of interest considered occluded as a function of the number of reference points of interest.

If the value of this ratio exceeds a predetermined threshold, the corresponding active area is considered to be disturbed. Conversely, if the value of this ratio is less than or equal to the threshold used, the corresponding active area is considered not to be disturbed.

The list 275 of the disturbed active areas is obtained in this way.

FIG. 7, comprising FIGS. 7a and 7b, shows an example of comparison of an active area of a representation of a reference model to that of a comparison model to determine if the active area is disturbed. For clarity, the representation of the reference model is called the reference image and the representation of the comparison model is called the comparison image.

As shown in FIG. 7a, the reference image 700 here comprises an active area 705 itself comprising the two reference points of interest 710 and 715.

The comparison image 720 represented in FIG. 7b is not perfectly aligned with the reference image whose contour 725 is represented in the same frame of reference. Such alignment errors can notably result from the object tracking algorithm. The comparison image 720 comprises an active area 730 corresponding to the active area 705 of the reference image. The reference 735 represents the contour of the reference active area that is shifted relative to the comparison active area as are the reference and comparison images.

To locate the point corresponding to the reference point 710, a search window 740 centered on the point of the active area of the comparison image having the coordinate of the reference point 710 is used. Execution of the location step identifies the point 745. If the location of the point 745 is valid, there is no occlusion at the point 710.

Similarly, to find the point 750 corresponding to the reference point 715, a search window centered on the point of the active area of the comparison image having the coordinates of the reference point 715 is used. However, the execution of the location step does not here identify the point 750 corresponding to the point 715. Consequently there is occlusion at this point.

Thus using a number of points of interest it is possible to determine that the active area 705 is disturbed in the current image 720.

Returning to FIG. 2, and after determining the list of disturbed active areas, a recursive processing step (step 280) is effected to trigger actions (step 285). This processing depends on the target application type.

It should be noted that it is difficult in this type of application to determine contact between the hand of the user and the tracked object. A recursive processing step corresponding to a second validation step is consequently used for preference on the basis of one of the following methods:
recursive study by filtering in time of occluded active areas; thus if the user lingers in an active area, that corresponds to validation of the action over that area;
use of a threshold on the disturbances of the pose of the tracked object (if the object is static, for example placed on a table, but not fixed to the decor); the user can confirm their choice by causing the object to move slightly by applying pressure to the required active area; or
use of a sound detector to detect the noise of the collision interaction between the fingers of the user and the surface of the target object.

More generally, the data corresponding to the active areas is filtered. The filter used can in particular be a movement filter (if the object is moving too fast in the image, it is possible block detection). The filter used can also be a recursive filter with the occlusion states stored for each active area in order to verify the coherence of the occlusion in time and thereby to make the system more robust in terms of false detection.

FIG. 8 shows diagrammatically a second embodiment of the method of the invention, here not using active areas of the object to be tracked. However, it should be noted that active areas can nevertheless be used in this embodiment. A difference operator between a reference model and a comparison model is used here to detect a particular action enabling interaction of the user with an augmented reality scene. Such an embodiment is adapted in particular to detect occlusion in areas that are poor in terms of the number of points of interest.

As indicated above, the method comprises a first part 800 corresponding to the initialization phase and a second part 805 corresponding to the processing effected on line to detect in real time, in a sequence of images, interactions between a user and an augmented reality scene.

The initialization phase essentially comprises the steps 810 and 815. The step 810, the object of which is to create reference models 820, is here similar to the step 210 described with reference to FIG. 2.

To use an algorithm for calorimetric subtraction between two images, it is necessary to make the reference models more robust in the face of variations in brightness, shadows and noise present in the video signal. Disturbances can therefore be generated from the reference model.

The variations generated on the reference model are, for example:
disturbances of the pose of the image;
calorimetric disturbances;
disturbances of luminous intensity; and
noises best corresponding to a video signal, for example uniform or Gaussian noise.

A training step (step 815) here has the object of creating a Gaussian model 825 on each component of the video signal. This step consists for example in determining and storing a set of images representing the reference model (in the three-dimensional case, this is the texture, or UV map), these images comprising at least some of the disturbances described above.

In the case of an RGB signal, the training step is as follows, for example: for each pixel of all the disturbed images corresponding to the reference model, a Gaussian distribution model is determined. That model can consist of a median value (μ) and a standard deviation (σ) for each component R, G and B: <μR, σ_{RR}>, <μG, σ_{GG}>, <μB, σ_{BB}>.

It is equally possible to construct k Gaussian models in order to improve robustness to noise or to the pose estimation error linked to the tracking algorithm used. If a pixel of an image is too far from the constructed mean, a new Gaussian model is added. Accordingly, for each component R, G and B, a set of Gaussian models is determined: [<μR1, σ_{RR1}>, . . . <μRn, σ_{RRn}>], [<μG1, σ_{GG1}>, . . . <μGn, σ_{GGn}>], [<μB1, σ_{BB1}>, . . . , <μBn, σ_{BBN}>]).

The comparison operator 830 that will be used thereafter to detect interaction is preferably determined during this step of training the reference models.

The steps 840 to 855 produce the current image and the pose of the objects tracked therein are identical to the steps 240 to 255.

Likewise, the step 860 of extracting the comparison model 865 is similar to the step 260 for obtaining the comparison model 265.

The step 870 of comparing the reference and comparison models consists in applying the following operator, for example:
determination of the Mahalanobis distance between the Gaussian model and the current pixel having the components (R, G, B) according to the following equation:

$$v = \frac{{( μ R - R )}^{2}}{{σ}_{RR}} + \frac{{( μ G - G )}^{2}}{{σ}_{GG}} + \frac{{( μ B - B )}^{2}}{{σ}_{BB}} ;$$

and
if the calculated Mahalanobis distance (v) is above a predetermined threshold, or calculated as a function of the colorimetry of the current image, the pixel is marked as belonging to the foreground, i.e. as not belonging to the reference model;
if not, the pixel is marked as belonging to the background, i.e. as belonging to the reference model.

Following this step, a map 875 of pixels not belonging to the background, i.e. not belonging to the reference model, is obtained. The map obtained in this way represents the disturbed pixels.

In the same way, it is possible to determine the Mahalanobis distance between each current pixel and each of the k Gaussian models determined by the following equation:

$${v}_{k} = \frac{{( μ Rk - R )}^{2}}{{σ}_{RRk}} + \frac{{( μ Gk - G )}^{2}}{{σ}_{GGk}} + \frac{{( μ Bk - B )}^{2}}{{σ}_{BBk}}$$

A weight wi is associated with each of these k Gaussian models, this weight being determined as a function of its frequency of occurrence. It is thus possible to calculate a probability from these distributions and to deduce therefrom a map representing the disturbed pixels. These k Gaussian models are first constructed as described above during the training phase and can advantageously be updated during the steady state phase in order to adapt better to disturbances in the current image.

In the same way, it is possible to process the pixels by groups of neighbors in order to obtain a more robust map of occlusions.

It is possible to store the disturbed pixel maps recursively (step 880) and to apply mathematical morphology operators to extract groups of pixels in packets. A simple recursive operator uses an “and” algorithm between two successive disturbed pixel maps in order to eliminate the isolated pixels. Other standard operators such as dilation, erosion, closure or operators of analysis by connex components can equally be added to the process.

It is thereafter possible to use a contour extraction algorithm to enable comparison of that contour with predetermined contours in a database and thus to identify gestural commands and trigger corresponding actions (step 885).

It should be noted here that the first and second embodiments described above can be combined, some reference models or some parts of a reference model being processed according to the first embodiment whereas other are processed according to the second embodiment.

In a first example of use, the method offers the possibility to a user of interacting with planar real objects. Those objects contain a set of targets that are visible or not, possibly corresponding to active areas, associated with an action or a set of actions, that can influence the augmented reality scene. It should be noted that a number of planar object models can be available and the method include an additional recognition step to identify what object or objects to be tracked are present in the video stream. When they have been identified and their pose has been determined, those objects can trigger the appearance of different car designs, for example. It is then possible to point to the targets of each of the objects to trigger animations such as opening the doors or the roof or changing the color of the displayed vehicle.

In the same context of use, a puzzle type application can be put into place with the possibility for the user of solving puzzles using a dedicated sound and visual environment. These puzzles can equally take the form of quizzes in which the user must respond by occluding the area of their choice.

Still in the same context of use, it is possible to take control of a GUI (Graphical User Interface) type application to browse ergonomically within a software application.

In the case of a face tracking application, it is possible to add virtual eyeglasses if the user passes their hand over their temples or to add make-up if the cheeks are occluded.

In the case of object tracking of good quality, for example for rigid objects, it is possible to proceed to a background subtraction with no manual training phase as is usually necessary for this type of algorithm to be used. Moreover, using the described solution dissociates the user from the background at the same time as being totally robust in the face of movements of the camera. Combining this with an approach using a correlation operator, it is also possible to render the approach robust in the face of fast lighting changes.

FIG. 9 illustrates a second example of use where the detection of an interaction is linked to a modification of the tracked object and not simply to the presence of an exterior object masking at least partly the tracked object. The example given here targets augmented reality scenarios applied to children's books such as books with tabs that can be pulled to enable a child to interact with the content of the book in order to move the story forward.

The tabbed book 900 includes the page 905 on which an illustration is represented. The page 905 here comprises three openings 910-1, 910-2 and 910-3 enabling viewing of the patterns produced on mobile strips 915-1 and 915-2. The used patterns vary according to the position of the strips. Page 905 typically belongs to a sheet itself formed of two sheets, partially stuck together, between which can slide strips 915-1 and 915-2 one end of which, the tab, projects from the perimeter of the sheet.

For example, it is possible to view a representation of the moon in the opening 910-1 when the strip 915-1 is in a first position and a representation of the sun when this strip is in a second position (as shown).

The openings 910-1 to 910-3 can be considered as active areas, disturbance of which triggers an interaction. Accordingly, manipulating the tabs of the book 900 triggers actions through modification of the patterns of the active areas.

A shape recognition algorithm can be used to identify the actions to be executed according to the patterns identified in the active areas.

Actions can equally be executed by masking these active areas in accordance with the principle described above.

Finally, the method of the invention provides equally for the provision of an application that aims to move and position synthetic objects in a 3D space to implement augmented reality scenarios.

A device implementing the invention or part of the invention is shown in FIG. 10. The apparatus 1000 is a microcomputer, for example, a workstation or a game console.

The device 1000 preferably includes a communication bus 1002 to which are connected:
a central processing unit (CPU) or microprocessor 1004;
a read-only memory (ROM) 1006, which can contain the operating system and programs such as “Prog”;
a random-access (RAM) or cache memory 1008 including registers adapted to store variables and parameters created and modified during execution of the aforementioned programs;
a video acquisition card 1010 connected to a camera 1012;
a graphics card 1016 connected to a screen or to a projector 1018.

The device 1000 can optionally further comprise the following items:
a hard disk 1020 that can contain the aforementioned programs “Prog” and data that has been processed or is to be processed according to the invention;
a keyboard 1022 and a mouse 1024 or any other pointing device, such as an optical pen, a touch-sensitive screen or a remote control enabling the user to interact with the programs of the invention;
a communication interface 1026 connected to a distributed communication network 1028, for example the Internet, which is able to transmit and receive data;
a data acquisition card 1014 connected to a sensor (not shown); and
a memory card reader (not shown) adapted to read or write in a card data processed or to be processed in accordance with the invention.

The communication bus provides communication and interoperability between the various elements included in the device 1000 or connected to it. The representation of the bus is not limiting and, in particular, the central unit is able to send instructions to any element of the apparatus 1000 directly or via another element of the apparatus 1000.

The run time code of each program enabling the programmable device to execute the methods of the invention can be stored, for example on the hard disk 1020 or in read-only memory 1006.

In a different embodiment, the run time code of the programs could be received via the communication network 1028, via the interface 1026, to be stored in exactly the same way as described above.

The memory cards can be replaced by any information medium such as, for example, a compact disk (CD-ROM or DVD). The memory cards can generally be replaced by information storage means readable by a computer or by a microprocessor, integrated into a device or not, possibly removable, and adapted to store one or more programs execution whereof executes the method of the invention.

More generally, the program or programs can be loaded into one of the storage means of the device 1000 before being executed.

The central unit 1004 controls and directs the execution of the instructions or software code portions of the program or programs of the invention, which instructions are stored on the hard disk 1020 or in the read-only memory 1006 or in the other storage elements referred to above. On power up, the program or programs that are stored in a non-volatile memory, for example the hard disk 1020 or the read-only memory 1006, are transferred into the random-access memory 1008, which then contains the run time code of the program or programs of the invention, together with registers for storing the variables and parameters necessary for use of the invention.

The graphics card 1016 is preferably a 3D rendition graphics card adapted in particular to determine a two-dimensional representation from a three-dimensional model and texture information, the two-dimensional representation being accessible in memory and not necessarily being displayed.

To satisfy specific requirements, a person skilled in the field of the invention can naturally make modifications to the foregoing description.

1. Method of detection in real time of at least one interaction between a user and an augmented reality scene in at least one image from a sequence of images, said at least one interaction resulting from the modification of the appearance of the representation of at least one object present in said at least one image, this method being characterized in that it comprises the following steps:
in an initialization phase,
creation of at least one reference model associated with said at least one object;
processing of said at least one reference model;
in a use phase:
determination of the pose of said at least one object in said at least one image;
extraction of at least one comparison model from said at least one image according to said at least one object; and
comparison of said at least one processed reference model and said at least one comparison model as a function of said determined pose and detection of said at least one interaction in response to said comparison step.

2. Method according to claim 1, wherein said step of determination of the pose of said at least one object in said at least one image uses an object tracking algorithm.

3. Method according to claim 1, wherein said steps of the use phase are repeated at least once on at least one second image from said sequence of images.

4. Method according to claim 3, further comprising a step of recursive processing of the result of said comparison step.

5. Method according to claim 1, wherein said step of processing said at least one reference model comprises a step of definition of at least one active area in said at least one reference model, said method further comprising a step of determination of said at least one active area in said comparison model during said use phase, said comparison step being based on said active areas.

6. Method according to claim 5, further comprising the determination of at least one reference point in said at least one active area of said at least one reference model, said comparison step comprising a step of location of said at least one reference point in said active area of said comparison model.

7. Method according to claim 1, wherein said comparison step comprises a step of evaluation of the correlation of at least one part of said at least one processed reference model and at least one part of said at least one comparison model.

8. Method according to claim 1, wherein said comparison step comprises a step of evaluation of the difference of at least one part of said at least one processed reference model from at least one part of said at least one comparison model.

9. Method according to claim 1, wherein said step of creation of said reference model comprises a step of geometric transformation of homographic type of a representation of said at least one object.

10. Method according to claim 1, wherein said at least one comparison model is determined according to said pose of said at least one object, said step of extraction of said comparison model comprising a step of geometric transformation of homographic type of at least one part of said at least one image.

11. Method according to claim 1, wherein said step of creation of said at least one reference model comprises a step of determination of at least one Gaussian model representing the distribution of at least one parameter of at least one element of said reference model.

12. Method according to claim 11, wherein said comparison step comprises a step of evaluation of a measurement of a distance between at least one point of said comparison model corresponding to said at least one point of said reference model and said Gaussian model associated with said at least one point of said reference model.

13. Method according to claim 1, wherein said reference model comprises a three-dimensional geometric model and an associated texture, the method further comprising a step of determination, during said use phase, of a representation of said reference model according to said pose of said at least one object and according to said geometric model and said texture.

14. Method according to claim 1, further comprising a step of activation of at least one action in response to said detection of said at least one interaction.

15. Method according to claim 1, wherein said modification of the appearance of said at least one object results from the presence of an object, referred to as the second object, different from said at least one object, between said at least one object and the source of said at least one image.

16. Method according to claim 1, wherein said modification of the appearance of said at least one object results from a modification of said at least one object.

17. Computer program comprising instructions adapted to execute each of the steps:
in an initialization phase,
creation of at least one reference model associated with said at least one object;
processing of said at least one reference model;
in a use phase:
determination of the pose of said at least one object in said at least one image;
extraction of at least one comparison model from said at least one image according to said at least one object; and
comparison of said at least one processed reference model and said at least one comparison model as a function of said determined pose and detection of said at least one interaction in response to said comparison step.

18. Computer program according to claim 17, further comprising instructions adapted to execute each of the steps of definition of at least one active area in said at least one reference model and of determination of said at least one active area in said comparison model during said use phase, said comparison step being based on said active areas.

19. Computer program according to claim 17, further comprising instructions adapted to execute the step of evaluation of the correlation of at least one part of said at least one processed reference model and at least one part of said at least one comparison model.

20. Computer program according to claim 17, further comprising instructions adapted to execute each of the steps of determination of at least one Gaussian model representing the distribution of at least one parameter of at least one element of said reference model and of evaluation of a measurement of a distance between at least one point of said comparison model corresponding to said at least one point of said reference model and said Gaussian model associated with said at least one point of said reference model.

21. Computer program according to claim 17, further comprising instructions adapted to execute the step of activation of at least one action in response to said detection of said at least one interaction.

22. Device comprising means adapted to execute each of the steps of,
in an initialization phase,
creation of at least one reference model associated with said at least one object;
processing of said at least one reference model;
in a use phase:
determination of the pose of said at least one object in said at least one image;
extraction of at least one comparison model from said at least one image according to said at least one object; and
comparison of said at least one processed reference model and said at least one comparison model as a function of said determined pose and detection of said at least one interaction in response to said comparison step.

23. Device according to claim 22, further comprising means adapted to execute each of the steps of definition of at least one active area in said at least one reference model and of determination of said at least one active area in said comparison model during said use phase, said comparison step being based on said active areas.

24. Device according to claim 22, further comprising means adapted to execute the step of evaluation of the correlation of at least one part of said at least one processed reference model and at least one part of said at least one comparison model.

25. Device according to claim 22, further comprising means adapted to execute each of the steps of determination of at least one Gaussian model representing the distribution of at least one parameter of at least one element of said reference model and of evaluation of a measurement of a distance between at least one point of said comparison model corresponding to said at least one point of said reference model and said Gaussian model associated with said at least one point of said reference model.

26. Device according to claim 22, further comprising means adapted to execute the step of activation of at least one action in response to said detection of said at least one interaction.
